(19) United States
(12) Patent Application Publication
(10) Pub. No.: US 2006/0100874 A1
(43) Pub. Date: May 11, 2006

(54) Method for inducing a Hidden Markov Model with a similarity metric

(76) Inventors: Daniel A. Oblinger, New York, NY (US); Vittorio Castelli, Croton On Hudson, NY (US); Lawrence Bergman, Mount Kisco, NY (US); Tessa A. Lau, New York, NY (US)

Correspondence Address: DILWORTH & BARRESE, LLP, 333 EARLE OVINGTON BLVD., UNIONDALE, NY, 11553, US

(21) Appl. No.: 10/972,028

(22) Filed: Oct. 22, 2004

(51) Int. Cl. G10L 15/14

(52) U.S. Cl. 704/256.3

(57) ABSTRACT

A method for inducing a Hidden Markov Model (HMM) is provided. The method using a plurality of training observations and a distance function includes assigning at least one representative observation to each of a plurality of hidden states of the HMM; computing a distance between said at least one assigned representative observation and one of said training observation using the distance function, wherein said distance is computed for each assigned representative observation; and computing at least one of an E-Step and an M-Step of a Baum-Welch algorithm by incorporating said computed distance.

### BACKGROUND OF THE INVENTION

1. Field of the Invention

The invention relates to the construction of Hidden Markov Models (HMMs), and in particular to a method for biasing an algorithm that constructs the HMMs by means of a similarity metric.

2. Description of the Related Art

Hidden Markov Models (HMMs) are a well-known method for modeling the probability distributions of sequences of data. An introduction to HMMs and to an algorithm used to construct HMMs from observations, is presented in J. Bilmes, “A Gentle Tutorial On The EM Algorithm And Its Application To Parameter Estimation For Gaussian Mixture and Hidden Markov Models,” Technical Report ICSI-TR-97-021, International Computer Science Institute, Berkeley, Calif., 1997, (hereinafter referred to as Bilmes 97). Some of the fundamental concepts of Bilmes 97 are discussed below.

A probability distribution (P) over a number (i) of sequences of observations (O₁,O₂, . . . ) is called a Markov Chain. P(Oᵢ|Oᵢ₋₁, . . . , O₁)=P(Oᵢ|Oᵢ₋₁), namely, if the i^{th} symbol is conditionally independent of the symbols that occurred before the (i-1)^{st} symbol, given the (i-1)^{st} symbol. It is also common to say that observations O₁,O₂, . . . form a Markov Chain.

A probability distribution P over sequences of observations O₁,O₂, . . . is called a Hidden Markov Chain if for every observation Oᵢ there exists a hidden variable Xᵢ, and a probability distribution Q over sequences of pairs (O₁,X₁),(O₂,X₂), . . . such that

The Xᵢ's take value in a finite set;

P is the marginal of Q over sequences of observations O₁,O₂, . . . Marginal is the unique distribution over sequences of observations O₁,O₂, . . . induced by Q.

The hidden variables X₁,X₂, . . . form a Markov Chain;

Oₜ is independent of all other variables given Xₜ. If Xₜ=i, the chain is said to be in a state i at a time t.

The probability distribution P can be estimated from sequences of observations called training sets, using an algorithm known as the Baum-Welch algorithm, which is fully described in Bilmes 97. The Baum-Welch algorithm actually estimates Q and derives P from that Q estimation. More specifically, Q is determined by

The probability distribution of X₁:
πᵢ=Q(X₁=i)

The transition probability matrix A, whose entry in the i^{th} row, j^{th} column is Aᵢⱼ=Q(X_{t=i|X}ₜ₋₁=j)

The conditional probability distribution B of the observations given the corresponding hidden variables:
bₓ(oₜ)=Q(Oₜ=oₜ|Xₜ=x)

The Baum-Welch algorithm alternates between two phases. In the first phase, known as the E-step, the sequences of observations and the values of π, B, and A computed during the previous iteration, or the initial guesses during the first iteration, are used in the backwards-forwards procedure to compute the following quantities:

αᵢ(t)=Q(O₁=o₁, . . . ,Oₜ=oₜ, Xₜ=ᵢ), the probability of observing the first t observations and of being in a state i at a time t,

βᵢ(t)=Q(Oₜ₊₁=oₜ₊₁, . . . ,O_{T}=o_{T}|Xₜ=i), the probability of observations from t+1 to the end of the sequence T, given that the state at time t is i.

The above quantities and the values of π, B, and A computed during the previous iteration are further used to compute the following:

γᵢ(t)=Q(X_{t=i|O}₁=o₁, . . . ,O_{T}=o_{T}), the conditional probability of being in a state i at a time t given the entire sequence of observations, and
ξᵢⱼ(t)=Q(Xₜ=i, Xₜ₊₁=j|O₁=o₁, . . . ,O_{T}=o_{T}), the probability of being in state i at time t and in state j at time t+1 given the entire sequence of observations.

During the second phase, known as the M-step, given the quantities computed in the E-step, the values of π, B, and A are updated.

A special case of HMM, called Input-Output HMM (IOHMM) is described in Y. Bengio and P. Frasconi, “Input-Output HMM's for Sequence Processing,” IEEE Trans. Neural Networks, 7(5):1231-1249, September 1996. In that case, each observation consists of an input-output pair, and the Baum-Welch algorithm is used to compute the conditional distribution of the outputs given the inputs. The IOHMM is implemented using a pair of classifiers for each of the states in the following model:

a transition classifier that embodies a conditional probability distribution over the states given the input and the state; and

an action classifier that embodies a conditional probability distribution over the outputs given the input and the state.

The Baum-Welch algorithm is a computationally expensive algorithm. In general, it produces triple values π, B, and A that correspond to a local maximum of the likelihood of the data. In general, there are multiple maximums.

A need exists for a method for enhancing the Baum-Welch algorithm, or, more generally, to induce HMMs from data. Such an enhanced algorithm should have an advantage of producing an assignment of observations to states that can provide valuable insights into the structure of the source that generates the sequence of observations.

### SUMMARY

The present invention teaches a method for inducing Hidden Markov Models (HMMs) from data, based on a similarity function between symbols, such that dissimilar symbols are associated with different hidden states, that has the advantage of making the task of induction less computationally expensive than existing methods. The inventive method includes an advantage of producing an assignment of observations to states that can be used to provide valuable insights into the structure of the source that generates the sequence of observations.

The present invention achieves the following benefits and improvements over the prior art:

1. A dramatic improvement in training time by assigning samples to states based on similarity, which:
a. effectively reduces the number of samples associated with each state, and correspondingly, the cost of inference; and
b. makes the HMM easier to interpret by a user by assigning semantic meaning to the states.

2. Improvement over the prior art that requires constructing multiple HMMs and selecting the one with better performance by using a similarity function to enable a simple and effective method for selecting an initial model for the HMM without having to construct the HMM.

3. Providing a natural way of initializing the HMM using representative observations and a distance function, rather than performing a commonly used random initialization or using more complex methods. 4. Improving on existing methods described in H. Singer and M. Ostendorf, “Maximum Likelihood Successive State Splitting,” Proceedings of 1996 IEEE International Conference on Acoustics, Speech, and Signal Processing, vol. 2, pages 601-604 1996, that require splitting each state and selecting the split that maximizes a predefined objective function. This is achieved by using a similarity function to provide a simple method for deciding when to add a new state to the model.

5. Allowing for extension of the inventive methods to different types of HMMs, including IOHMM, while retaining the advantages listed above.

The invention describes a method for inducing a Hidden Markov Model (HMM) using a plurality of training observations and a distance function including assigning at least one representative observation to each of a plurality of hidden states of the HMM; computing a distance between said at least one assigned representative observation and one of said training observation using the distance function, wherein said distance is computed for each assigned representative observation; selecting an initial number of hidden states using the computed distance; initializing the Baum-Welch algorithm using the computed distance; and computing at least one of the E-Step and M-Step of the Baum-Welch algorithm by incorporating said computed distance.

### BRIEF DESCRIPTION OF THE DRAWINGS

The foregoing and other objects, aspects, and advantages of the present invention will be better understood from the following detailed description of preferred embodiments of the invention with reference to the accompanying drawings in which.

FIG. 1 is a flowchart showing extension of the Baum-Welch algorithm in accordance with an embodiment of the present invention;

FIG. 2 is a flowchart of a method for selecting the initial number of states of a Hidden Markov Models (HMMs), having features according to a preferred embodiment of the present invention;

FIG. 3 is a flowchart of a method for improving the E-Step of the Baum-Welch algorithm, having features according to a preferred embodiment of the present invention;

FIG. 4 is a flowchart of a method for re-computing the representative observations of hidden states during execution of the Baum-Welch algorithm according to a preferred embodiment of the present invention; and

FIG. 5 is a flowchart showing a method for dynamically adding new states to the HMM according to a preferred embodiment of the present invention.

### DETAILED DESCRIPTION OF THE PREFERRED EMBODIMENT

Preferred embodiments of the present invention will now be described in detail herein below with reference to the annexed drawings. In the drawings, the same or similar elements are denoted by the same reference numerals even though they are depicted in different drawings. In the following description, a detailed description of known functions and configurations incorporated herein has been omitted for conciseness.

For the present application, the following definitions are proposed:

(O¹₁, . . . ,O¹_{T1}), . . . , (O^{N}₁, . . . ,O^{N}_{TN}) is a collection of N sequences of observations, where the observations take value in a set O. It is desired to use that collection of sequences to induce a Hidden Markov Model (HMM) describing their distribution. This collection is called a training set, each sequence is called a training sequence, and each observation is called a training observation.

d(o₁, o₂) is a distance between pairs of elements of O. The present invention teaches a method for inducing an HMM using the distance function d having the following property:
The expected disimilarity (measured by d) of two symbols O₁ and O₂ generated while in the same hidden state is smaller than the expected dissimilarity of two symbols O₃ and O₄ generated while in different hidden states.

The distance function d is selected by an expert and is tailored to requirements of the specific application domain where the method is applied.

The number of hidden states may be given, as commonly taught in the art. Alternatively, the number of hidden states may be determined by an appropriate method, for example a method described in A. Barron, J. Rissanen, and B. Yu, “The Minimum Description Length Principle in Coding and Modeling”, IEEE Transactions on Information Theory, 44(6):2743-2670, October 1998 (hereinafter referred to as Barron 98).

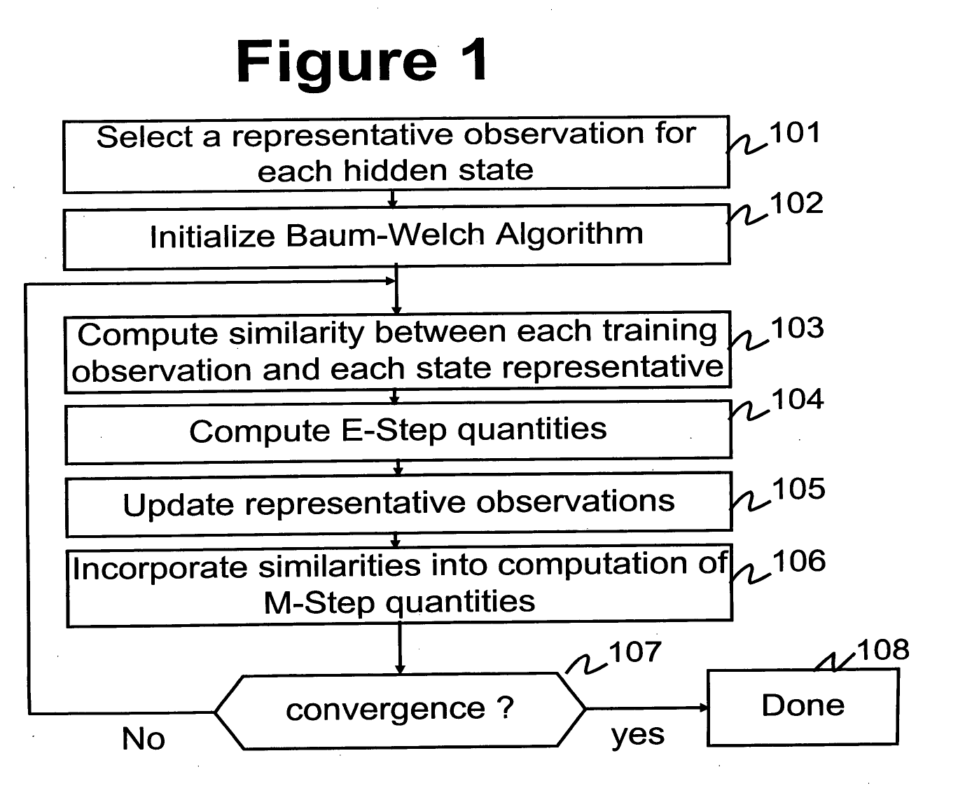

FIG. 1 is a flowchart describing the inventive method for extending the Baum-Welch algorithm. In Step 101, a representative observation is selected for each hidden state from among the training observations. In Step 102, the Baum-Welch algorithm is initialized by selecting initial values of π, B, and A. In Step 103, the similarity between each training and representative observation is computed using the distance function d. Those of ordinary skill in the art would recognize that this computation can be performed with a distance function as well as with any other function capturing similarity or dissimilarity between observations.

In Step 104, E-Step quantities are computed, as described above in the background section of this application. In Step 105, the representative observations are updated. In Step 106, the M-Step quantities are computed by including the similarities computed by the E-Step computation in Step 104. In the present invention these similarities are included directly or in the E-Step quantities used to compute the M-Step quantities. In the present case, the manner in which Step 104 incorporates the similarities computed in Step 103 into the computation of the E-Step quantities is novel and is not taught in the prior art. In Step 107, it is determined whether the algorithm has converged. If the algorithm has converged, it is terminated in Step 108, otherwise the computation continues from Step 103.

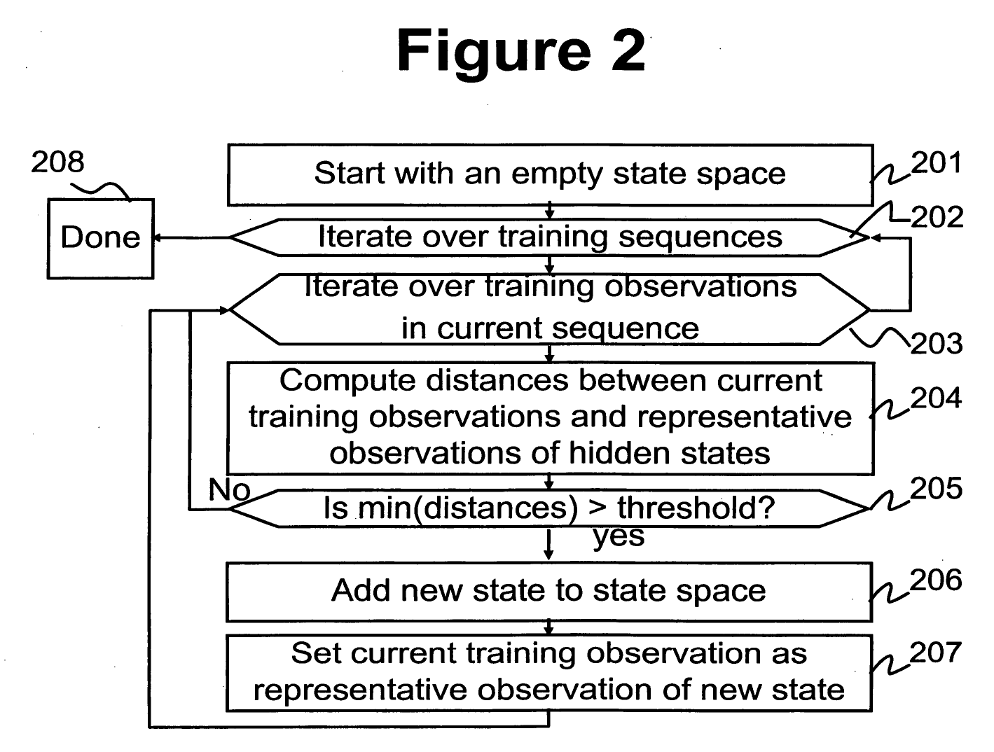

In one preferred embodiment of the present invention, the selection of representative observations performed in Step 101 includes randomly assigning a representative observation per each hidden state. In another preferred embodiment, which is described below with reference to FIG. 2, a number of hidden states is simultaneously selected and assigned a representative sample. For the purposes of the present application, a collection of hidden states is called a state space.

Referring to FIG. 2, in Step 201, the state space is initialized to an empty set. In Step 202, the state space is iterated over the training sequences. After the last training sequence is exhausted, the method is terminated in Step 208. In Step 203, the state space is iterated over the observations of the current sequence. When the last observation of the current sequence has been examined the process returns to Step 202. In Step 204, the differences between the current training observations selected in Step 203, and all the representative observations of the hidden states are computed. In various embodiments of the present invention, the differences computed in step 204 are determined according to distances, similarities, or dissimilarities between the current training observations and all the representative observations of the hidden states.

In Step 205, the smallest distance computed in Step 204 is compared to a threshold T. In one preferred embodiment, the threshold T may be selected by the user. In another embodiment, where differences are computed based on similarities, the threshold is set to 0 to denote complete dissimilarity. In a third embodiment, where differences are computed based on dissimilarities, the threshold is 0, to denote complete similarity. If, in Step 205, the minimum difference is not greater than the threshold, the process returns to Step 203. Otherwise, if the minimum difference is greater than the threshold, a new state is added to the state space in Step 206, the current training observation is set as the representative observation of the current state in Step 207, and the processing returns to Step 203.

Those of ordinary skill in the art would appreciate that in accordance with the current invention, Step 201 may be a combination of Step 201 described with reference to FIG. 2 and of the embodiment described with reference to Step 101 of FIG. 1. That is, instead of starting with an empty state space, Step 201 may start with a non-empty set, where the states have randomly assigned representative samples. In such a situation, the method described with reference to FIG. 2 may be used to adaptively enlarge the state space. The novelty of such method is two-fold:
1. The method uses the distance function to select the number of hidden states, and
2. The method performs the selection during initialization.

The prior art (see Barron 98) teaches selecting the initial number of states by fixing a collection of possible values for the number of states, performing the Baum-Welch algorithm with each of the values in the collection, and comparing the resulting HMMs. The method described in FIG. 2 is substantially more efficient than the prior art since it requires the construction only of a single HMM.

In a preferred embodiment of the present invention, Step 103 described with reference to FIG. 1, is achieved by performing a random assignment of the joint distributions of the observations and of the corresponding hidden states. This approach is described in Arne Leijon, “HMM Training, Practical Aspects,” Lecture Notes, Dept. Of Speech, Music, and Hearing, The Royal Institute of Technology, Stockholm, Sweden, 2003.

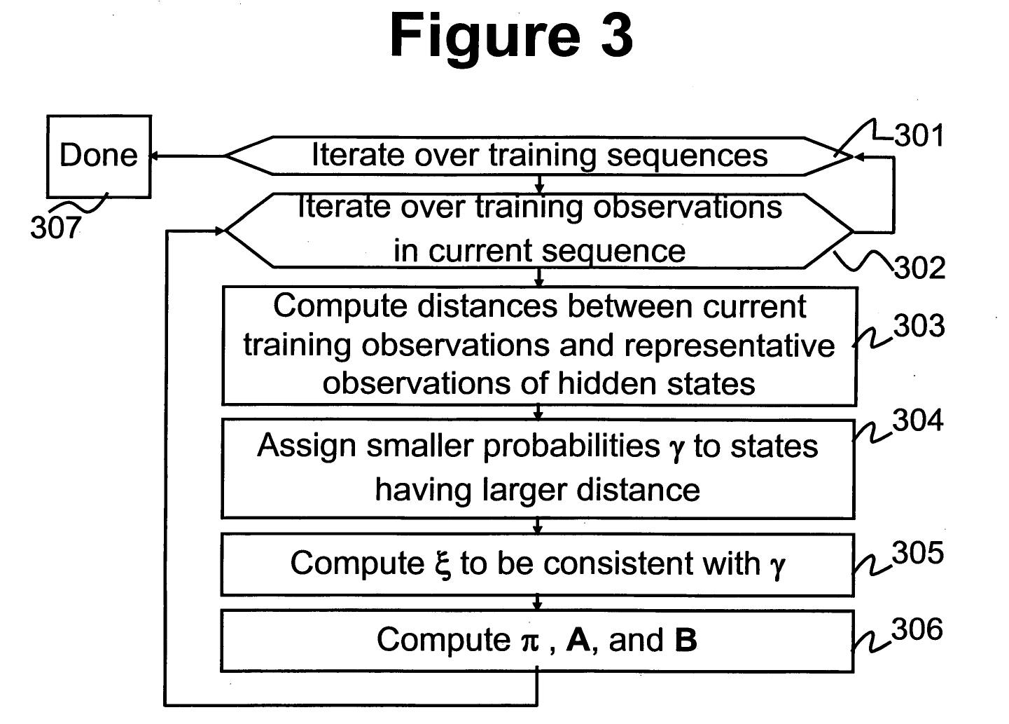

In another embodiment, described below with reference to FIG. 3, the initialization Step 103 of FIG. 1 is performed using the representative samples and the distance function d. In Step 301 the training sequences are iterated and, when all the training sequences have been examined, terminated in Step 307. In Step 302 the training observation in the training sequence, selected in Step 301, are iterated. In Step 303, the distances between the observation selected in Step 302 and the representative observations of the hidden states are computed. In Step 304, states x with larger distances are assigned smaller values of γₓ. γₓ is a probability of state x at the time of the selected observation, given the sequence to which the observation belongs. It would be obvious to those skilled in the art that assignment of smaller probabilities, performed in Step 304, may be achieved using similarity or dissimilarity measurements as easily as with distances. In a preferred embodiment, Step 304 includes selecting a non-increasing function called a kernel function K, and setting Equation (1) as follows:

$${γ}_{x} ( t ) = \frac{K ( d ( {O}_{t} , {O}_{x} ) )}{Σ K ( d ( {O}_{t} , {O}_{z} ) )} \qquad ( 1 )$$

where Oₜ is the observation selected in Step 303, e.g., the observation number t of the sequence, Oₓ is the representative observation of state x, O_{z} is the representative observation of state z, and the sum in the denominator is over all states z in the state space.

In Step 305, ξᵢⱼ is computed to be consistent with the values of γₓ (Step 304). Finally, the initial values of π, B, and A are computed from γₓ and ξᵢⱼ as taught in the art, in Step 306 and the process repeats starting in step 302. In a preferred embodiment, the Step 306 computation consists of setting Equation (2) as follows:
ξᵢⱼ(t)=γᵢ(t−1)γⱼ(t) (2)
which is consistent with the values of γₓ computed in Step 303, because the quantities satisfy the following Equation (3):

$${\sum }_{j} {ξ}_{ij} ( t ) = {γ}_{j} ( t ) , \qquad ( 3 )$$

namely, the desired consistency requirement.

In a preferred embodiment, Step 104 includes incorporating the distances computed in Step 103 into the computation of the E-step quantities, as follows: compute the γⱼ(t) as described in the art; then multiply γⱼ(t) by Equation (4) (which is equivalent to Equation (1)):

$$\frac{K ( d ( {O}_{t} , {O}_{j} ) )}{Σ K ( d ( {O}_{t} , {O}_{z} ) )} \qquad ( 4 )$$

and finally normalize the collection γ₁(t), . . . , γₓ(t), where X is the number of states in the state space.

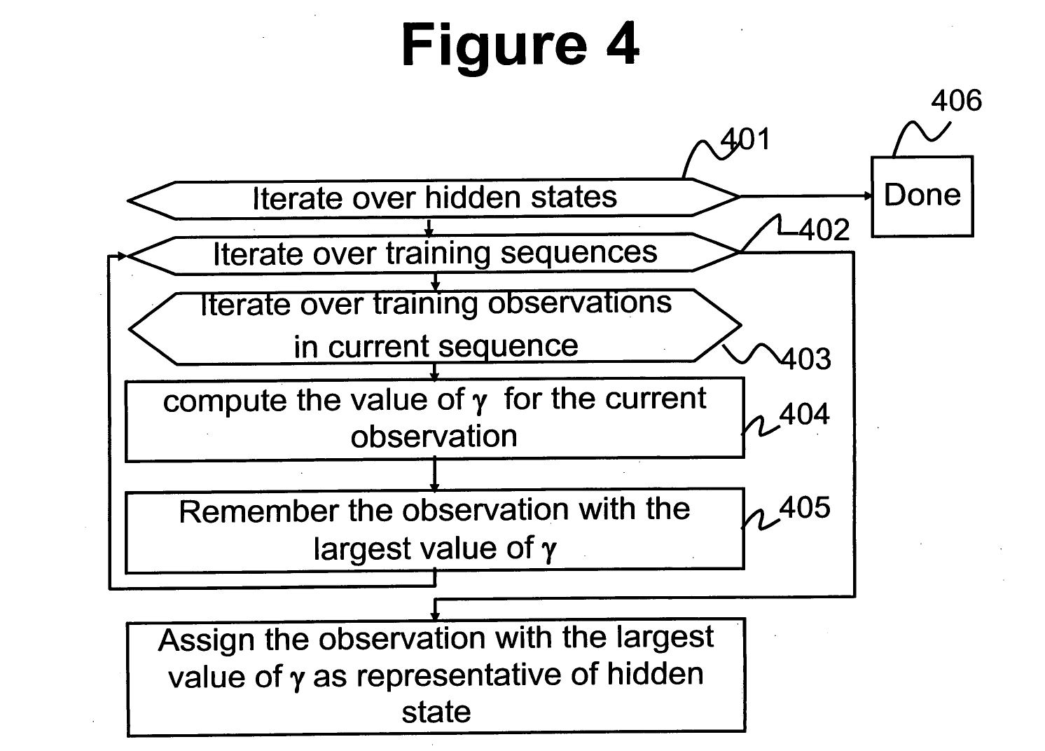

In the preferred embodiment, Step 105 (FIG. 1) is performed in accordance with a flowchart illustrated in FIG. 4. Step 401 iterates over the hidden states until all states have been examined, after which the method terminates in Step 406. Steps 402, 403, 404, and 405 are repeated for each hidden state. For the hidden state selected in Step 401, step 402 iterates over all training sequences; therefore steps 404 and 405 are repeated for each step of each training sequence.

In Step 403 the training observation of the training sequence selected in Step 402 is iterated. Step 404 is repeated for each training observation of each training sequence, and consists of computing the conditional probability γ of being the hidden state selected in Step 401. In Step 405, the computed conditional probability γ is compared to the largest value obtained in the previous iterations of Steps 402 and 403 during the current iteration of Step 401. If the value γ computed in Step 404 is larger than the largest value computed so far, the value γ is remembered together with its corresponding observation. Once all iterations of Steps 402 and 403 for the current iteration of Step 401 are concluded, in Step 406, the observation with the largest value of γ computed in Step 405 is assigned to the state selected in Step 401.

It would be apparent to those of ordinary skill in the art that Steps 105 and 106 of FIG. 1 may be executed in any order when Step 105 is performed in accordance with the method of FIG. 4, or in accordance with other methods that do not use the results of Step 106 to perform computations of Step 105.

In another embodiment of the present invention, each hidden state includes multiple representative observations. For example, the methods described with reference to FIGS. 2 and 4 can be easily adapted by those of ordinary skill in the art to return k observations having highest values of γ, that are then used as representatives of the hidden state.

In the preferred embodiment, each representative observation of a hidden state has an associated score, that represents how strongly the observation and the hidden state are associated. For example, those of ordinary skill in the art would appreciate that the values of γ associated with the k selected observations can be used as scores. Then all the algorithms taught in this application for the case where each hidden state has a unique representative observation can be extended to k representative observations by substituting distances with weighted distances, hence the dissimilarity between a state X and an observation is defined in Equation (5) as:
D(X,O)=sₓⁱd(Oₓⁱ,O) (5)
where Oₓⁱ is the i^{th} representative observation of the state x, and sₓⁱ is its normalized score, and the sum is taken over the representative observations of state x. In another embodiment, the quantity K(d(Ox,O)) may be replaced by Equation (6)
K(X,O)=sₓⁱK(d(Oₓⁱ,O)) (6)
Extention of the methods taught in the present application to either embodiment is understood by those of ordinary skill in the art.

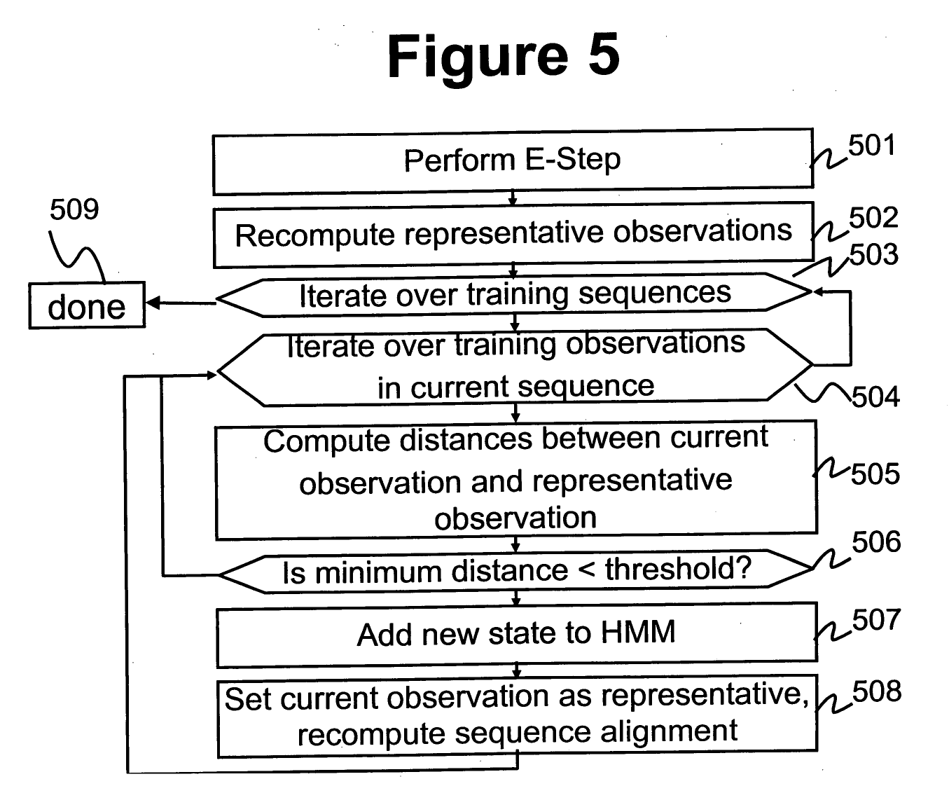

FIG. 5 illustrates a preferred embodiment for dynamically adding new states to the HMM during execution of the Baum-Welch algorithm. In Step 501, the E-Step is performed as a combination of Steps 103 and 104 described with reference to FIG. 1, while Step 502 is equivalent to Step 105 which was also described with reference to FIG. 1. In Step 503 the training sequence is iterated, and in Step 504 iteration of the observations of the sequence selected by Step 503 is performed. If it is determined in Step 504 that no more observations are left in the selected sequence, the process returns to Step 503 for selecting the next trace, or for terminating the computation in Step 509.

Steps 505 to 508 are repeated for each observation selected in Step 504. In Step 505 the distance between the observation selected in Step 504 and the representative observations of the existing states is computed. In Step 506 the minimum of these distances is compared to a threshold. If the minimum distance is less than or below the threshold, the process returns to Step 504 for selection of the next observation in the trace. Otherwise, the process continues in Step 507, where a new state is added to the HMM. In Step 508, the current observation is set as representative of the new state and the alignment of the sequences is recomputed to account for the new state.

In a preferred embodiment, the HMM is an IOHMM, and the enhancement of the IOHMM using the distance function is called a SimIOHMM, where the prefix “Sim” stands for “Similarity”. Structurally, the SimIOHMM includes the IOHMM, a collection of representative inputs, a distance function between inputs d(.,.), and a finite-support kernel function K(.). Representative inputs, distance, and kernel are incorporated in the Baum-Welch algorithm. Formally, the input-output pair (U,Y) can be substituted for the observation O in the classical Baum-Welch algorithm and the Baum-Welch algorithm can then be obtained for the SimIOHMM.

The E-Step is then formally analogous to that of the classical HMM. The M-step updates three sets of quantities: the initial probability distribution on the states, the state-transition probability distribution A, which in the IOHMM is a mapping from the state space times the input space to the set of probability distributions over the state space; and the conditional probability distribution B of the observations given the states. The chain rule for probability yields the following Equation (7):
bₓ(u,y)=Q(Y=y|X=x, U=u)Q(U=u|X=x)₂ (7)
Both IOHMM and SimIOHMM estimate π using the standard approach, B with the transition classifier learning algorithm, and Q(Y=y|X=x, U=u)$ with the output classifier learning algorithm.

While the IOHMM ignores the term Q{X=x|U=u}, the SimIOHMM in the preferred embodiment of the present invention estimates Q{X=x|U=u} using Bayes' rule to expand, as follows in Equation (8):

$$Q ( X = x \text{\textbackslash} mid U = u ) = \begin{matrix}Q ( U = u ) \\ Q ( X = x \vert U = u ) \\ Q ( X = x )\end{matrix} \qquad ( 8 )$$

The third term of the above equation, Q(X=x), is estimated from the γₓ(t), the conditional probabilities of being in a state x at a time t given the observed value of a sequence k computed in the previously performed E-Step . The term Q(U=u) can be estimated from the data using the Maximum Likelihood Estimator or other estimators familiar to those skilled in the art. The distinguishing characteristics of the SimIOHMM described in the preferred embodiment of the present invention is the estimation of Q(X=x|U=u), performed by computing the distances between u and the representative input of each state, using these distances as inputs to the kernel function, and combining the results with the Nadaraya-Watson kernel density estimator as follows in Equation (9):

$$Q ( X = x \vert U = u ) = \frac{K ( d ( u , {U}_{x} ) )}{K ( d ( u , {U}_{z} ) )} \qquad ( 9 )$$

where Uₓ is the representative input of state x, and the sum in the denominator is over all states z. Other methods of converting similarity between inputs into probabilities can be used in conjunction with the SimIOHMM.

A derivation from the preferred embodiment is an embodiment where the SimIOHMM may use a distance function that uses both inputs and outputs, and the representative samples are input-output pairs would be understood by those of ordinary skill in the art and thus will not be described herein.

The methods of the preferred embodiment of the present invention are used to capture procedural knowledge by performing alignment and generalization of observed procedure traces. Other methods described herein are used to construct autonomic advisors using demonstrations and associating scores to training sequences. These scores are scores for the entire sequence, or scores for the individual observations and can be extended to the case of scored sequences of observations.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for inducing a Hidden Markov Model (HMM) using a plurality of training observations and a distance function, the method comprising the steps of:
assigning at least one representative observation to each of a plurality of hidden states of the HMM;
computing a distance between said at least one assigned representative observation and one of said training observation using the distance function, wherein said distance is computed for each assigned representative observation; and
computing at least one of an E-Step and an M-Step of a Baum-Welch algorithm by incorporating said computed distance.

2. The method of claim 1, further comprising the step of selecting an initial number of hidden states using said computed distance.

3. The method of claim 1, further comprising the step of initializing the Baum-Welch algorithm using said computed distance.

4. The method of claim 1, wherein one representative observation is assigned in said assigning step.

5. The method of claim 1, wherein a number of representatives observations specified by a user is assigned in said assigning step.

6. The method of claim 1, wherein said assigning step further includes a step of associating a score to said at least one representative observation assigned to each of the plurality of hidden states.

7. The method of claim 6, wherein all computed distances are combined using said score associated with said at least one representative observation.

8. The method of claim 1, further comprising a step of converting all computed distances into probabilities.

9. The method of claim 8, wherein said converting step is achieved by using a Kernel Density Estimator.

10. The method of claim 1, further comprising the step of adaptively selecting the number of states based on said distance function.

11. The method of claim 10, wherein said adaptively selecting step further includes a step of executing a Baum-Welch algorithm based on said distance function and adaptively adding new states during said execution.

12. The method of claim 11, wherein said executing step further includes a step of setting said at least one representative observation of said added new states based on said distance function.

13. The method of claim 1, wherein the HMM is a Similarity Input-Output HMM (SimIOHMM).

14. The method of claim 13, wherein said distance function is performed on inputs.

15. The method of claim 13, wherein said distance function is performed on input-output pairs.

16. The method of claim 13, where said distance function prformed on outputs.

17. The method of claim 1, further comprising a step of capturing procedural knowledge by means of the HMM.

18. The method of claim 17, wherein said capturing step further includes a step of constructing an autonomic advisor from said procedural knowledge.

19. The method of claim 1, wherein each of said plurality of training observations includes an assigned score prior to initiation of inducting the HMM.
